(19) United States
(12) Patent Application Publication
(10) Pub. No.: US 2003/0016184 A1
(43) Pub. Date: Jan. 23, 2003

(54) Resonant length multi-element helical antenna

(76) Inventors: David R. Kitching, Boulder, CO (US); Vincent A. Hirsch, Boulder, CO (US); Robert A. Wootten, Boulder, CO (US); J. Mark Rogers, Golden, CO (US)

Correspondence Address: SHERIDAN ROSS PC, 1560 BROADWAY, SUITE 1200, DENVER, CO, 80202

(21) Appl. No.: 09/907,102

(22) Filed: Jul. 17, 2001

(51) Int. Cl. H01Q 1/36

(52) U.S. Cl. 343/895

(57) ABSTRACT

A resonant length, helical antenna is provided. According to an embodiment, the antenna includes a plurality of filars having different lengths and that are separately excited in order to provide a wide bandwidth. The bandwidth of the antenna may be further increased by providing switches to selectively terminate an end of the filars in either an open circuit or a short circuit to ground. According to another embodiment, the antenna is provided with a single helical element. The antenna provides efficient operation across a wide bandwidth, particularly at frequencies having good penetration characteristics through the earth. In addition, the antenna provides a radiation pattern having good coverage along an axis of the antenna. The antenna is particularly well suited for use in connection with horizontal directional drilling operations in which it is desirable to avoid contacting underground objects.

### FIELD OF THE INVENTION

The present invention relates to multi-element helical radio frequency antennas. In particular, the present invention relates to resonant length multi-element helical antennas, in which each element of the antenna is a different length and is separately excited.

### BACKGROUND OF THE INVENTION

Antennas are used to radiate or receive radio wave signals. The transmission and reception of radio wave signals is useful in a broad range of activities. For instance, radio wave signals may be transmitted, and a reflection of the transmitted signals received, to determine the relative position of a remote object and the antenna. Such radar systems are useful in a variety of applications.

One application of a radar system is in connection with a horizontal directional drill. In general, a horizontal directional drill allows drilling to be performed in a direction that is substantially horizontal and it allows the direction of the drill to be altered as the bore hole is created. Usually, the horizontal directional drill is inserted into the ground at a relatively shallow angle. The drill is rotated and directed by an engine and associated control station located on the surface and connected to the drill by a drill string. The use of horizontal directional drilling allows various conduits, such as pipelines and communications channels, to be positioned under ground with a minimum of disruption to the surface.

In directing the path of a horizontal directional drill, maps indicating the location of underground obstacles, such as existing conduits or structural foundations, are commonly consulted. However, such maps are often inaccurate. In addition, the actual position of the drill is often uncertain. Accordingly, it is not uncommon for horizontal directional drills to come into contact with conduits or structures. As can be appreciated, damage occurring as a result of such contact can be expensive to repair, and can present a hazardous situation, such as where a natural gas pipeline or electrical conduit is contacted. Therefore, it would be desirable to provide a method and an apparatus that provided accurate information concerning the position of a horizontal directional drill with respect to conduits and other structures in or near the path of the horizontal directional drill.

Antenna systems for use in connection with underground drilling applications have been developed. For instance, dipole radiator antennas running axially along the drill string have been used in connection with vertical bore holes. A transmitting antenna in a first bore hole can then be used in connection with a receiving antenna in a second bore hole to map underground structures between the bore holes. Because the resonant dimension of a dipole antenna is its length, and because the length of an antenna disposed along the length of the drill string can be very great, dipole antennas used in connection with such bore hole tomography can operate at the low frequencies necessary for good penetration of the ground. In addition, dipole antennas have a maximum radiation direction that is perpendicular to the length of the antenna. However, such antennas provide poor performance in an axial direction. Furthermore, modifying a dipole antenna to radiate energy in the direction of travel of the horizontal drill is not a practical solution, as the length of the dipole antenna would then be limited to the diameter of the drill. Accordingly, the operating frequency of a dipole antenna adapted for the transmission and reception of radio waves along the axis of the drill would be much higher than the frequency necessary to obtain good underground performance.

Other systems have employed antennas in connection with horizontal directional drills in order to keep the drill positioned within a desired stratum of earth. For example, systems have been provided that make reference to a log of resistivity of strata. This log may be obtained in connection with the drilling of a vertical well from which resistivity information as a function of depth is obtained. A directional well that is initially vertical is started, and is turned substantially horizontal when a selected stratum is reached. The position of the drill is maintained within the selected stratum by taking resistivity readings and comparing them to the model of resistivities developed from the log. Based on these comparisons, the directional drilling can be adjusted to maintain the drill string within the desired stratum. Accordingly, such systems are concerned with the resistivity of the earth surrounding the drill. However, such systems do not provide an indication of the position of structures such as conduits or building foundations in the path of the drill. Therefore, such systems are of little value in avoiding such structures in connection with horizontal drilling operations used to emplace conduits.

Another antenna for use in connection with underground drilling utilizes a transmitting antenna and a receiving antenna located on a downhole tool. The antennas are bow-tie shaped dipole antennas, and are designed to map the boundaries of mineral seams. Accordingly, the antennas are predominantly side looking, and are not well-adapted to detecting obstacles in front of the drill. Additionally, the size of the antennas is electrically small, limiting them to use in connection with frequencies that are higher than are necessary for good penetration of the ground.

Helical antennas having a maximum radiation intensity directed along the axis of the antenna are known. A typical helical antenna includes a number of turns along the length of the antenna and functions as a traveling wave antenna. However, the in-ground performance of such antennas is relatively poor. In addition, such antennas are relatively long.

Another type of helical antenna is the standing wave helix, or volute. The volute is capable of performing with increased efficiency underground as compared to a traveling wave helix. In addition, the length of a volute is generally much shorter than a comparable traveling wave antenna. However, a conventional volute employing a single filar length has a relatively narrow bandwidth. Because of its narrow bandwidth, a conventional volute is incapable of providing the necessary bandwidth for use in connection with determining the position of a horizontal directional drill.

In many applications, helical antennas are used that include multiple filars of equal length that are excited in a turnstile fashion. For example, the four elements of a quadrafilar antenna may be driven in quadrature (i.e. the four filars are driven sequentially in a 0, −90, −180, and −270 degree phase excitation pattern). This configuration, when combined with a hybrid coupler feed network provides a means for obtaining obstacle angle of arrival information using sum and difference amplitude and phase. However, the filar spacing necessary to provide a reasonable difference pattern is too small electrically (e.g., about 0.012 wavelengths) for use in connection with a horizontal directional drill.

Therefore, there is a need for a method and an apparatus for providing an antenna suitable for use in connection with determining the position of underground obstacles with respect to a horizontal directional drill. In particular, there is a need for a method and apparatus for providing such an antenna that is capable of providing the required radiation characteristics and bandwidth for such an application. Furthermore, there is a need for such an antenna capable of being dimensioned so that it can be used in connection with a horizontal directional drill. In addition, such an antenna should be reliable and inexpensive to manufacture.

### SUMMARY OF THE INVENTION

In accordance with the present invention, a resonant length, multi-element helical antenna is disclosed. The antenna includes a plurality of antenna elements, each of which is a different length, and each of which is excited over a different range of frequencies. The antenna of the present invention provides a radiation pattern having good coverage along an axis of the antenna, and is capable of operating in connection with frequencies having good penetration of the ground.

In accordance with one embodiment of the present invention, the antenna includes a cylindrical support member. A plurality of antenna filars are wrapped about the support member in a partial spiral. Each of the filars is a different length. According to one embodiment, the partial spiral is from about ¼ of a revolution to about five revolutions. Each filar may complete the same partial spiral on a particular antenna. According to a further embodiment of the present invention, the antenna filars may be provided with a feed at a first end. In addition, the filars may be provided with a switch at a second end to selectively terminate the filars in either an open circuit or a short circuit to ground.

In accordance with an embodiment of the present invention, each filar has a length equal to an odd multiple of a quarter of the wavelength of an operating frequency of the particular filar. According to still another embodiment of the present invention, each filar has a length equal to a multiple of one-half of the wavelength of an operating frequency applied to that filar when it is shorted to ground at a second end. The operating frequency of each filar may be a unique center frequency, and each filar may be used in connection with the transmission and reception of radar frequency signals at frequencies that are lower and higher than the center frequency.

In accordance with another embodiment of the present invention, four filars are arranged in a spiral about the exterior of a cylindrical support member. Each of the filars has a different length, and each of the filars completes the same number of revolutions about the support member. For example, according to one embodiment of the present invention, the filars complete as many as five revolutions. As a further example, according to another embodiment of the present invention, the spiral may be from about ¼ to about 1 revolution. The length of the filars is determined by the principal operating frequency of the particular filar. The end of the filars opposite the feed end may each be provided with a switch to selectively terminate each filar in either an open circuit or a short circuit to ground.

In accordance with still another embodiment of the present invention, a method for providing an antenna resonant at a predetermined range of frequencies is provided. The method generally includes providing a plurality of single filar antenna elements, each having a different length. The antenna elements are arranged in at least a partial spiral about a common cylindrical support member. The spiral, according to one embodiment, may be a plurality of revolutions. According to a further embodiment, the at least a partial spiral may be from about ¼ to about 1 revolution. A first of the filars is excited at at least a one of a first range of frequencies. The length of the first filar is related to at least a one of the frequencies included in the first range of frequencies in that it is an odd multiple of a quarter of the wavelength of the at least a one frequency.

According to a further embodiment of the present invention, the method includes selectively switching an end of a first filar opposite the feed end between an open circuit and a short circuit to ground. When the end of the filar is terminated in an open circuit, it is excited at a range of frequencies including at least one frequency having a ¼ wavelength that is divisible into the length of the filar an odd number of times. When the filar is terminated in a short circuit to ground, the filar is excited at a range of frequencies including at least one frequency having a ½ wavelength that is divisible into the length of the filar an integer number of times.

According to yet another embodiment of the present invention, a helical antenna for use in connection with horizontal directional drilling is provided. The antenna may include one or more filars that complete from about ¼ to about five revolutions about a support member.

The support member may be formed from a dielectric material. In addition, the support member is mounted about the drill string of a horizontal directional drill, such that it is concentric with the drill string.

According to still another embodiment of the present invention, cross-overs are provided to prevent shorting between filars arranged about the support member such that they overlap one another.

Based on the foregoing summary, a number of salient features of the present invention are readily discerned. A multi-element helical antenna is provided. The elements or filars of the antenna of the present invention each have a different length, corresponding to a different operating frequency or range of frequencies. In addition, the antenna elements may be configured as a standing wave antenna, or volute, in that each element completes no more than one revolution over the length of the antenna. Alternatively, the antenna elements may complete multiple revolutions. Switches may be provided to selectively terminate each element in either an open circuit or a short circuit to ground. The provision of antenna elements having different lengths, and of switches to selectively terminate the elements in an open circuit or a short circuit to ground allows the antenna to cover a wide range of operating frequencies. For example, an antenna in accordance with the present invention having four filars, each of which can be selectively terminated in either an open circuit or a short circuit to ground, can cover a 16 to 1 bandwidth ratio. In addition, the antenna of the present invention provides good radiation coverage along the axis of the antenna, and is capable of operating efficiently at frequencies having good ground penetration characteristics.

Additional advantages of the present invention will become readily apparent from the following discussion, particularly when taken together with the accompanying drawings.

### BRIEF DESCRIPTION OF THE DRAWINGS

FIG. 1 is a diagrammatic illustration of a horizontal directional drill having an antenna in accordance with an embodiment of the present invention;

FIG. 2 depicts a radiation pattern produced by an antenna in accordance with an embodiment of the present invention;

FIG. 3 is a block diagram depicting the relationship between various functional aspects of a horizontal directional drill system in accordance with an embodiment of the present invention;

FIG. 4A is a perspective view of an antenna in accordance with an embodiment of the present invention having two filars and having switches at a terminal end of the filars;

FIG. 4B is a feed end view of the antenna of FIG. 4A;

FIG. 5 is a perspective view of an antenna in accordance with an embodiment of the present invention having four filars;

FIG. 6 is a perspective view of an antenna in accordance with an embodiment of the present invention having four filars and switches at a terminal end of each of the filars, and having a crossover;

FIG. 7 is a flow chart illustrating operational aspects of an antenna constructed in accordance with an embodiment of the present invention; and

FIG. 8 is a perspective view of an antenna in accordance with an embodiment of the present invention having four filars that each complete about four revolutions.

### DETAILED DESCRIPTION

In accordance with the present invention, a resonant length, multi-element helical antenna is provided.

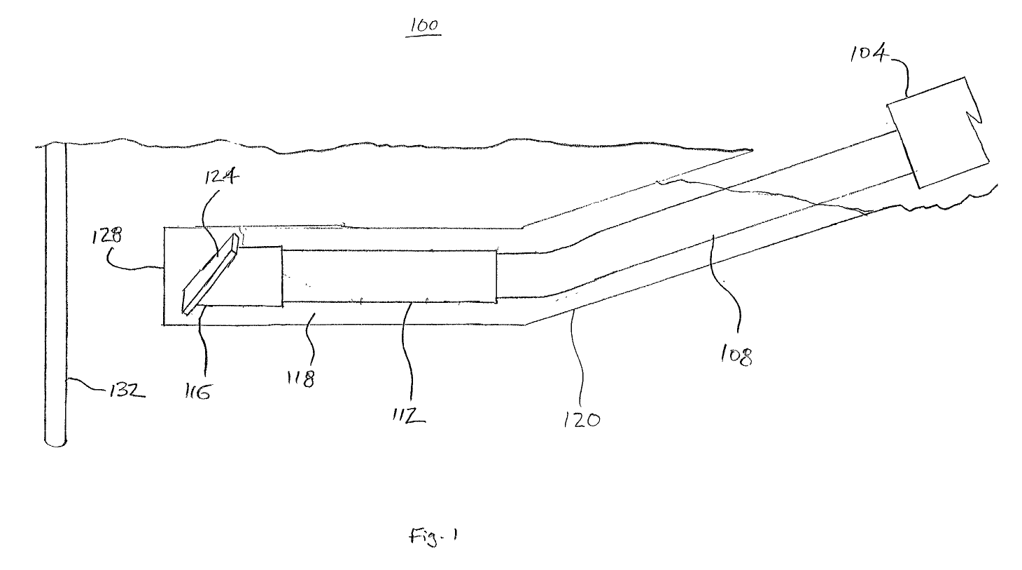

With reference to FIG. 1, a horizontal directional drill system 100 in accordance with the present invention is depicted. The system 100 generally includes a base unit 104, a drill string 108, a resonant length multi-element helical antenna 112, and a drill 116. In general, the base unit 104 include an engine (not shown) for rotating the drill string 108 and in turn the antenna 112 and the drill 116. A slurry compound 118 is used to remove earth as the bore hole 120 is formed. The direction of the bore hole 120 created by the drill 116 can be controlled by an operator stationed at the base unit 104. In general, the bore hole 120 is formed in a straight line by rotating the drill string 108 and in turn the drill 116. In order to change the direction of the bore hole 120, the angled spade 124 of the drill 116 is pushed against the front wall 128 of the bore hole 120. The change in direction is achieved by rotating the drill 116 to align the spade 124 so that the drill 116 is deflected in the desired direction as the spade 124 is forced against the front wall 128. By controlling the direction of the drill 116, the bore hole 120 may be placed so as to avoid obstacles 132, and to generally position the bore hole 120 as required in the particular application. As shown in FIG. 1, the drill 116, antenna 112 and at least a portion of the drill string 108 are positioned underground when the horizontal directional drill system 100 is in operation, and are typically surrounded by the slurry 118. Generally, the slurry 118 is pumped down the drill string 108, and is removed by traveling in the space between the drill string 108 and the bore hole 120.

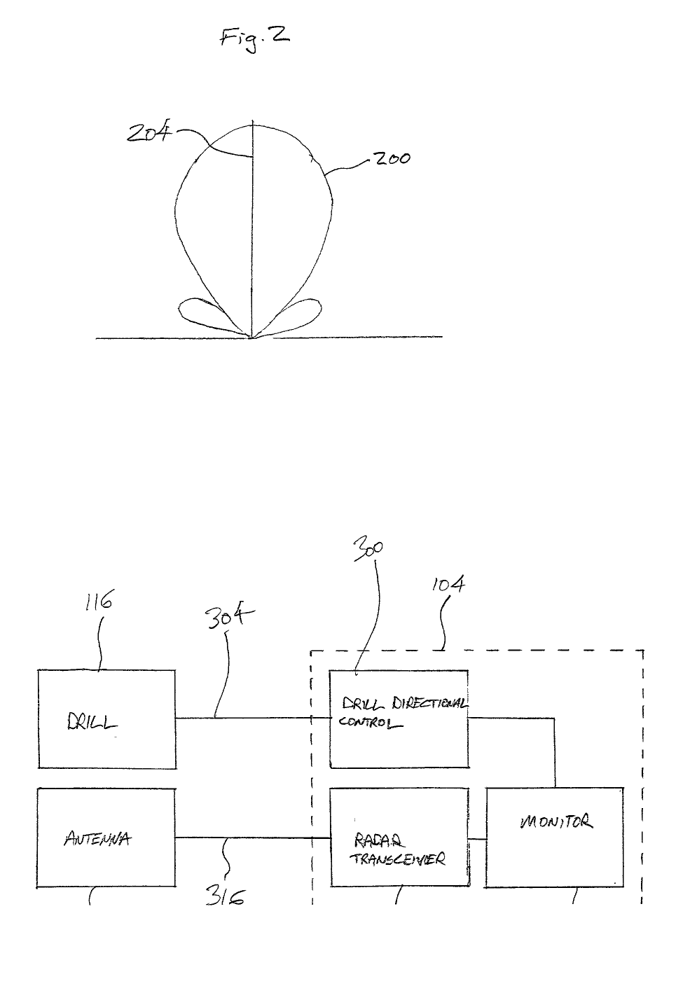

With reference now to FIG. 2, the general shape of a radiation pattern 200 produced by an antenna 112 in accordance with an embodiment of the present invention is illustrated. The axis 204 in FIG. 2 is aligned with the longitudinal axis of the antenna 112. Accordingly, it can be appreciated that the antenna 112, being of a helical design, as will be discussed in greater detail below, and having a radiation pattern 200 as generally depicted in FIG. 2, provides good front to back coverage. Therefore, the antenna 112 can efficiently project a radar signal in the direction of travel of the drill 116. In addition, the antenna 112 has good sensitivity to radar signals that have been reflected back towards the drill 116 by obstacles 132 in the path of the drill 116.

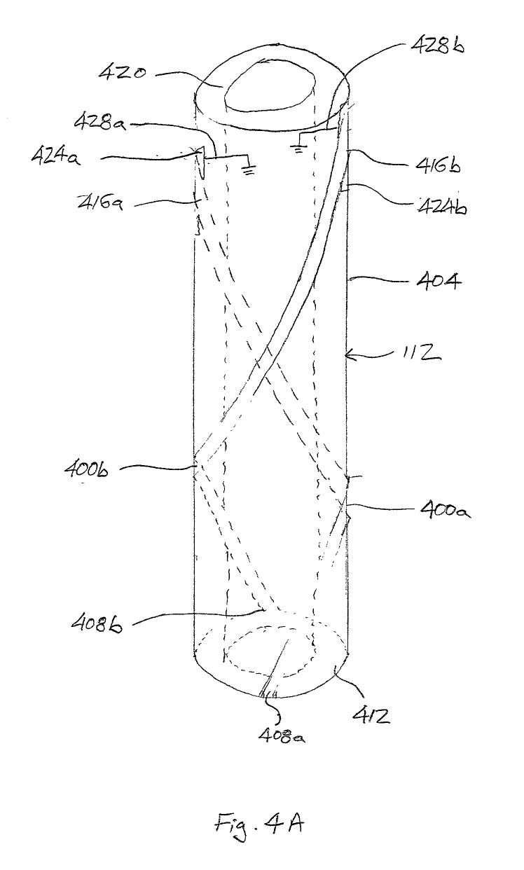

With reference now to FIG. 3, certain of the relationships between functional aspects of the horizontal directional drilling system 100 are depicted. In general, the direction of the drill 116 can be controlled by an operator at the base station 104 through the drill directional control unit 300. The drill control signal line 304 generally travels along the drill string 108 between the drill 116 and the base unit 104, and may provide information regarding the orientation of the drill 116 from a down-hole sensor (not shown). In controlling the direction of the drill 116, the operator may make reference to a graphical and/or numerical representation of the position of the drill 116 provided by a monitor 308. The monitor 308 may be provided with position information from the drill directional control unit 300 and from a radar transceiver 312. The monitor 308 may also provide a graphical representation of objects in or near the path of the drill 116, such as an obstacle 132. As an alternative or in addition, the monitor 308 may provide an alarm to the operator if the drill 116 is determined to be in close proximity to an obstacle 132. Accordingly, it can be appreciated that the monitor 308 need not provide a visual display to the user. An embodiment providing only an audible alarm may be desirable in certain applications because it is less distracting to the operator than is a continuous display.

In general, the position of an obstacle 132 relative to the drill 116 is obtained by generating a radar frequency signal in the radar transceiver 312 and passing that radar frequency signal to the antenna 112 for transmission. Discontinuities in the earth within the radiation pattern 200 of the antenna 112, such as may be caused by conduits, structures or other obstacles 132, will reflect the radar frequency signal back to the antenna 112. The reflected signal is received by the antenna 112 and provided to the radar transceiver 312 for analysis. The phase and angle of the reflected signal allow the relative position of an obstacle 132 to be determined. According to one embodiment of the present invention, radar frequency signals are transmitted, and reflected signals are therefore received, continuously. By switching to different frequencies, a phase slope of the reflected signals can be generated. Information regarding the distance of obstacles 132 from the antenna 112 can be obtained by performing an inverse Fourier Transform of the phase information. It is advantageous to be able to transmit a broad range of frequencies from the antenna 112 in order to obtain more complete range information.

The information received by the radar transceiver 312 may be conveyed to the operator of the horizontal directional drilling system 100 using the monitor 308. Generally, transmitted and received signals are passed between the radar transceiver 312 and the antenna 112 over radar frequency signal line 316, which travels along or is integral with the drill string 108.

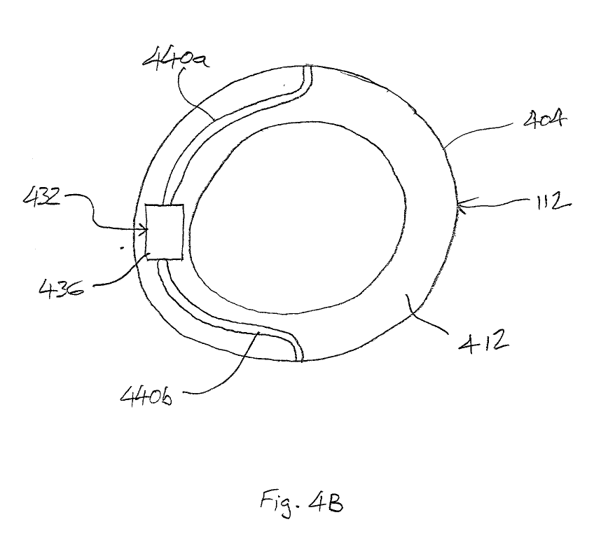

With reference now to FIG. 4A, an antenna 112 in accordance with an embodiment of the present invention is illustrated. The antenna 112 shown in FIG. 4A is generally configured as a fractional turn, fractional wavelength volute. The antenna 112 illustrated in FIG. 4 has a first, or high frequency filar 400a, and a second, or low frequency, filar 400b. The filars 400a, 400b are wrapped about a support member or cylinder 404. The first filar 400a extends from a feed end 408a, located at a first end 412 of the support member 404, to a terminus 416a, located towards a second end 420 of the support member 404. The first filar 400a can be seen to complete ¾ of a revolution about the support member 404 from the feed end 408a to the terminus 416a. The second filar 400b extends from a feed end 408b located at the first end 412 of the support member 404 to a terminus 416b located towards the second end 420 of the support member 404. The second filar 400b can be seen to complete ¾ of a revolution about the support member 404 from the feed end 408b to the terminus 416b. Accordingly, it can be appreciated that the antenna 112 illustrated in FIG. 4 is configured as a volute, or a standing wave helical antenna. In general, the first end 412 of the support member 404 may be adjacent to the drill 116 while the second end 420 of the support member 404 may face the base unit 104. Therefore, the antenna 112 is a back firing device adapted to transmit and receive signals along the path of the drill 116.

It will be noted that the first 400a and second 400b filars terminate 416a and 416b at different distances along the support member 404. This is because the first filar 400a is adapted for use at a higher frequency than the second filar 400b, and therefore the first filar 400a has a shorter length, and because both filars 400a, 400b complete ¾ of a revolution about the support member 404.

In accordance with one embodiment of the present invention, the filars 400a, 400b are connected to switches 424a, 424b at the terminal ends 416a, 416b of the filars 400a, 400b. The switches 424a, 424b may be selectively and independently operated to terminate the filars 400a, 400b in either an open circuit or a short circuit to ground over grounding conductors 426a, 428b. That is, when switch 428a is open, the first filar 400a is terminated in an open circuit. When switch 428a is closed, the terminal end 416a of the first filar 400a is short circuited to ground through grounding conductor 428a. Similarly, when switch 424a is open, the second filar 400b is terminated in an open circuit. Likewise, when switch 424b is closed, the terminal end 416b of the second filar 400b is shorted to ground by grounding conductor 428b.

With reference now to FIG. 4B, a feed assembly 432 in accordance with an embodiment of the present invention is illustrated. The feed assembly 432 generally includes a distribution block 436 and transmission lines 440a and 440b. The distribution block 436 is supplied with radar frequency signals for transmission from the radar transceiver 312 via the radar frequency signal line 316. The radar frequency signal line 316 may, in accordance with one embodiment of the present invention, be a 50 Ohm coaxial cable. The distribution block 436 may include switches (not shown) for selectively providing a signal for transmission to a selected one of the transmission lines 440. The transmission lines 440 are each connected to a corresponding filar 400. The feed assembly 432 may additionally be provided with additional features for impedance matching purposes, as will be appreciated by those of ordinary skill in the art.

When the antenna 112 is in operation, the feed assembly 432 directs the signal for transmission to the appropriate filar 400. For example, the first filar 400a is provided with those frequencies that are within the range of operating frequencies associated with the first filar 400a. Radar frequency signals reflected back to the antenna 112 that are within the range of operating frequencies of the first filar 400a are received by the first filar 400a and provided to the radar transceiver 312 by the feed 432 and the radar frequency signal line 316. Similarly, the second filar 400b is provided with a radar frequency signals within a second range of frequencies, and receives radar frequency signals from within that second range of frequencies. Although the operation of the first 400a and second 400b filars is similar, the center frequencies of the filars 400a, 400b, i.e., the frequency at about the center of each filar's 400 range of operating frequencies, are different. In general, the filars 400a, 400b have lengths that are determined by the wavelength oftheir respective center frequency. That is, the first 400a and second 400b filars are adapted for use over a range of frequencies, with their respective lengths being tailored to about the center of the respective operating frequencies. In this way, the antenna 112 is capable of efficiently sending and receiving a broader range of frequencies than would otherwise be possible.

The operation of the switches 424a, 424b may be controlled by electronics in the base unit 104. For example, controlling electronics may be a part of the radar transceiver 312. In general, when a filar 400 is terminated in an open circuit, the length of the filar 400 is related to the operating wavelengths of the filar 400 in that the length of the filar 400 is an odd ¼ multiple of the wavelength of the center operating frequency. When the filars 400 are terminated in a short circuit to ground, the lengths of the filars 400 are related to their operating frequencies in that the lengths of the filars 400 are integer multiples of ½ the wavelength of their respective operating frequencies. Accordingly, by switching between open circuit and short circuit operation of the filars 400, the bandwidth of the antenna 112 can be increased.

The filars 400 may be constructed from any electrically conductive material. In accordance with one embodiment of the present invention, the filars 400 are constructed from strips of aluminum. The support member 404 has a cylindrical outer surface. The support member 404 may be constructed from a dielectric material. Furthermore, the support member 404 may be hollow, so that it can be mounted concentrically about the drill string 108 or an extension of the drill string 108. Preferably, the outside diameter of the support member 404 is less than the diameter of the bore hole 120 created by the drill 116, to reduce wear on the antenna 112 from abrasion, and to allow for a protective coating to be placed over the antenna 112. For example, the antenna 112 may be covered by a ceramic coating.

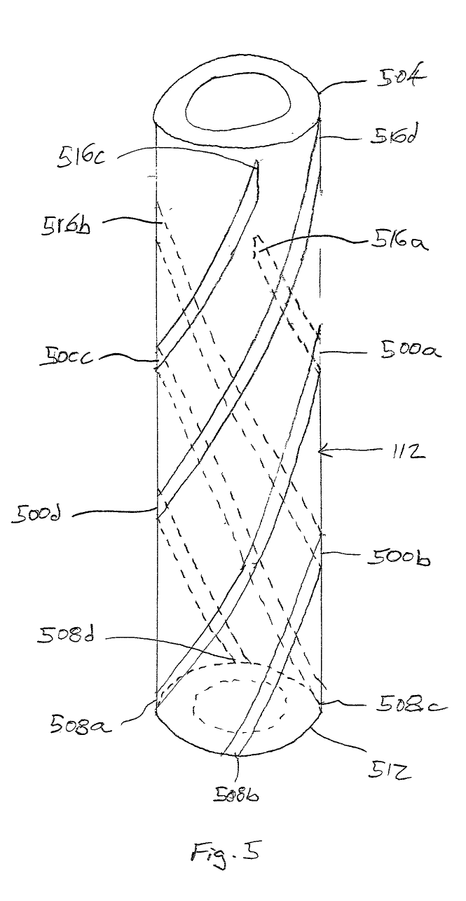

With reference now to FIG. 5, an antenna 112, in accordance with an embodiment of the present invention, having four filars 500a, 500b, 500c and 500d is illustrated. In the embodiment illustrated in FIG. 5, each of the filars 500a-d is a different length. Accordingly, each of the filars 500a-d is adapted for excitation at a different center frequency, allowing the antenna 112 illustrated in FIG. 5 to have a greater effective bandwidth than an antenna having only two filars. As is apparent from FIG. 5, the feed ends 508a, 508, 508c and 508d of the filars 500a-d are aligned with the first end 512 of the support member 504. However, each of the filars 500a-d has a terminus 516a, 516b, 516c and 516d at a different distance along the support member 504. This is because each of the filars 500a-d completes about ¾ of a revolution as it extends along the length of the support member 504, and because each of the filars 500a-d has a different length. As can be appreciated, the feed (not shown) for the antenna 112 illustrated in FIG. 5 would include a four position switch at the distribution point so that the filars 500a-d can be selectively used in connection with those frequencies that they can most efficiently transmit and receive.

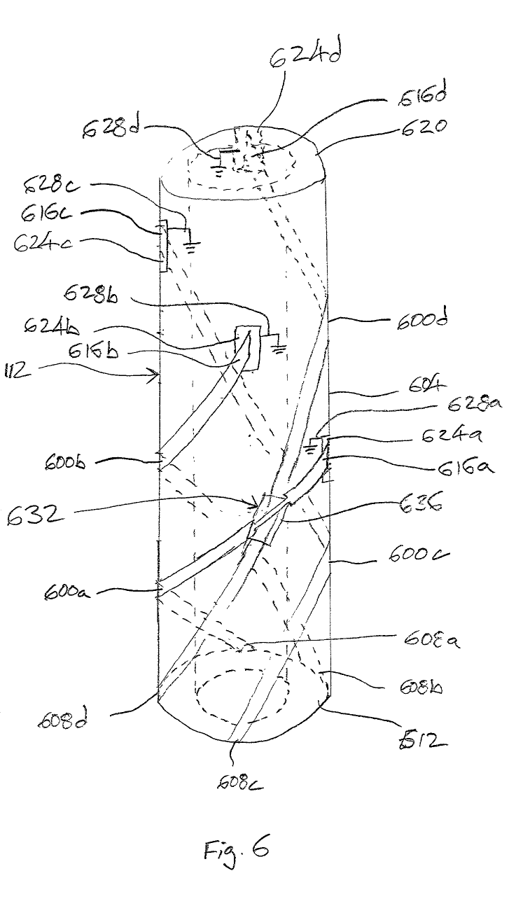

With reference now to FIG. 6, yet another embodiment of an antenna 112, in accordance with the present invention, is illustrated. The antenna 112 depicted in FIG. 6 includes four filars 600a, 600b, 600c and 600d. Each of the filars 600a-d has a feed end 608a, 608b, 608c and 608d aligned with a first end 612 of the support member 604. In addition, the longest of the filars 600d extends along substantially the entire length of the support member 604, from the first end 612 to the second end 620. However, each of the other filars 600a-c extends a shorter distance along the support member 604. This is because each of the filars 600a-d is a different length, and because each of the filars 600a-d completes about ¾ of a revolution about the support member 604. Each of the filars 600a-d is a different length so that each is capable of efficient operation at a different operating frequency or range of frequencies. By choosing appropriate filar 600a-d lengths, the antenna 112 can provide efficient operation over a broad bandwidth ratio.

In order to increase the efficient operating bandwidth of the antenna 112 further, switches 624a, 624b, 624c and 624d are provided at the terminal ends 616a, 616b, 616c and 616d of the filars 600a-d. Each of the switches 624a-d can be operated to selectively terminate its corresponding filar 600a, 600b, 600c or 600d in either an open circuit, or a short circuit to ground through grounding conductors 628a, 628b, 628c and 628d. For example, the grounding conductors 628a-d may interconnect the ends 616a-d of the filars 600a-d to the drill string 108 when the switches 624a-d are closed. By providing the switches 624a-d, the electrical characteristics of the filars 600a-d can be altered, allowing the antenna 112 to operate efficiently over a wider range of frequencies. Provided that the lengths of the filars 600a-d and their operating frequencies are carefully chosen, the antenna 112 having four filars 600a-d and from corresponding switches 624a-d is capable of efficient operation over about a 16 to 1 bandwidth ratio.

It will be appreciated that the antenna 112 illustrated in FIG. 6 includes a feed to selectively interconnect the filars 600 to the radar transceiver 312. In addition, it will be appreciated that the feed includes a distribution block having a four-position switch. However, unlike the feed used in connection with the antenna 112 shown in FIG. 5, the feed for the embodiment illustrated in FIG. 6 interconnects the filars 600 to the radar transceiver 312 in connection with frequencies in any of two ranges, rather than one, as in the embodiment shown in FIG. 5. This is because the ability to selectively ground the ends 616 of the filars using the switches 624 allows the filars 600 to be used in connection with both first and second frequency ranges.

The embodiment of the antenna 112 illustrated in FIG. 6 can be seen to have a crossover 632 between filars 600a and 600d. The crossover 632 is the result of the particular geometry of the antenna 112 illustrated in FIG. 6. Specifically, the diameter of the support member 604 and the different lengths of the filars 600a and 600d causes the filars 600a and 600d to intersect at the crossover 632. At the point of intersection (i.e. at the crossover 632) measures are taken to reduce or eliminate any alteration to the electrical characteristics of the filars 600a and 600d that would otherwise be caused by their intersecting. For instance, the filars 600a and 600d may be separated by a dielectric material (represented by box 636) to prevent electrical contact between the filars 600a and 600d. Alternatively, one of the filars (for instance, 600a) may pass through the interior of the support member 604 at the crossover 632, such that it passes under the intersecting filar 600d, thereby avoiding direct electrical contact.

According to a first exemplary embodiment of the present invention, an antenna 112 for use in connection with guiding a horizontal directional drill so as to avoid obstacles generally has a quadrafilar configuration, as illustrated in FIG. 5. The antenna 112 in this first example may be adapted to work over a 16 to 1 bandwidth ratio when used in soils having appropriate characteristics, such as bentonite. The first filar is operated at frequencies from 25-50 MHz, the second from 50-100 MHz, the third from 100-200 MHz, and the fourth from 200-400 MHz. Accordingly, each filar is used in connection with the transmission and reception of one octave of the total frequency range of the antenna 112. In operation, the frequencies may be swept in a series of steps. For example, the total range of from 25 to 400 MHz may be passed through in steps of approximately 2 MHz. Alternatively, an equal number of steps may be traversed within each frequency range. According to this alternative embodiment, the steps between frequencies would be greater in connection with the high frequency filar 500a than in connection with the low frequency filar 500d.

According to a second exemplary embodiment of the present invention, an antenna 112 for use in connection with guiding a horizontal directional drill so as to avoid obstacles generally has a quadrafilar configuration with switches 624 as illustrated in FIG. 6.

The antenna 112 of this second exemplary embodiment of the present invention is adapted to work effectively across a 16 to 1 bandwidth ratio, and in connection with a slurry 118 having a dielectric constant of 27. In particular, the antenna 112 of this embodiment of the present invention is adapted for efficient operation at frequencies from 25 to 400 MHz. Switches 624a-d are provided for selectively grounding the ends 616a-d of the filars 600a-d to ground to extend the frequencies at which the antenna 112 is capable of operating efficiently. The fourth filar 600d has a length of about 19″, and an operating frequency range of about 25-35 MHz when the switch 624d at the terminus 616d of the filar 600d is open. The fourth filar 600d has an operating frequency range of about 50-70 MHz when the switch 624d is closed such that the terminus 616d is connected to ground. The third filar 600c has a length of about 13.2″ and an operating frequency range of about 35-50 MHz when the switch 624c at the terminus 616c of the filar 600c is open. The third filar 600c has an operating frequency range of about 70-100 MHz when the switch 624c is closed such that the terminus 616c is connected to ground. The second filar 600b has a length of about 4.7″ and an operating frequency range of about 100-141 MHz when the switch 624b at the terminus 616b of the filar 600b is open. The second filar 600b has an operating frequency range of about 200-280 MHz when the switch 624a is closed such that the terminus 616a is connected to ground. The first filar 600a has a length of about 3.3′ and an operating frequency range of about 141-200 MHz when the switch 624a at the terminus 616a of the filar 600a is open. The first filar 600a has an operating frequency range of about 280-400 MHz when the switch 624a is closed such that the terminus 616a is connected to ground.

The length of the support member 604 is about 24″ and the diameter of the support member 604 is about 2.375″. The support member 604 is constructed from a low dielectric material such as epoxy. The ground conductors 628a-d provide an earth ground by making contact with the drill string 108. The filars 600a-d are formed fromwire, having a diameter of about 0.06″. The antenna 112 is coated with a ceramic material such as ceramic loaded epoxy to protect the antenna 112 from abrasion as the antenna 112 moves through the bore hole.

The switches 624a-d may be PIN diodes. The operation of the switches 624a-d may be controlled by signals provided to the switches 624a-d from the radar transceiver 312. For instance, a forward DC bias may be provided to the PIN diode to short the terminus 616 of the associated filar 600 to ground, while a reverse DC bias may be provided to isolate the terminus 616 of the associated filar 600 from ground, thereby terminating that filar 600 in an open circuit. The signals controlling operation of the switches 624a-d may be provided over the radar frequency signal line 316 or another provided communication link between the switches 624a-d and the radar transceiver 312.

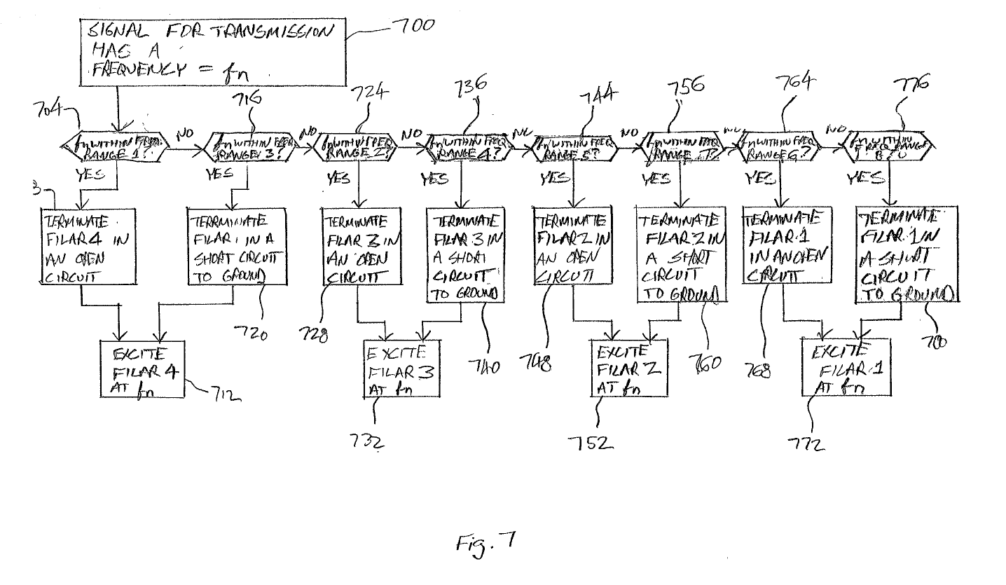

With reference now to FIG. 7, certain operational aspects of an antenna 112 constructed in accordance with an embodiment of the present invention will be explained. In particular, FIG. 7 may be best understood in connection with a quadrafilar antenna 112, such as the one illustrated in FIG. 6, having switches 624 for selectively connecting associated filars 600 to ground. Initially, a signal for transmission having a frequency equal to fₙ is provided to the antenna 112 by the radio transceiver 312. (Step 700). At step 704, a determination is made as to whether fₙ is within frequency range f₁. If fₙ is within frequency range f₁, filar 4 600d is terminated in an open circuit (step 708) and the signal is provided to filar 4 600d by the feed (step 712). If fₙ is not within frequency range f₁, a determination is made as to whether fₙ is within frequency range f₃ (step 716). If fₙ is within frequency range f₃, filar 4 600d is terminated in a short circuit to ground (step 720) and the signal having a frequency fₙ is provided to filar 4 600d (step 712) by the feed.

If fₙ is not within frequency range f₃, a determination is made as to whether fₙ is within frequency range f₂ (step 724). If fₙ is within frequency range f₂, filar 3 600c is terminated in an open circuit (step 728) and filar 3 600c is provided with the signal having a frequency of fₙ (step 732). If fₙ is not within frequency range f₂, a determination is made as to whether fₙ is within frequency range f₄ (step 736). Provided fₙ is within frequency range f₄, filar 3 600c is terminated in a short circuit to ground (step 740) and the signal is provided to filar 3 (step 732).

Should fₙ not be within frequency range f₄, fₙ is compared to f₅ (step 744). If fₙ is within frequency range f₃, filar 2 600b is terminated in an open circuit (step 748) and filar 2 600b is provided with the signal having a frequency fₙ (step 752). If fₙ is not within frequency range f₅, a determination is made as to whether fₙ is within frequency range f₇ (step 756). If fₙ is within frequency range f₇, filar 2 600b is terminated in a short circuit to ground (step 760) and filar 2 600b is provided with the signal having frequency of fₙ (step 752).

If the signal fₙ does not have a frequency within frequency range f₇, a determination is made as to whether the signal has a frequency within frequency range f₆ (step 764). If it does, filar 1 600a is terminated in an open circuit (step 768) and the signal is provided to filar 1 600a (step 772). If the signal has a frequency that is not within frequency range f₆, a determination is made as to whether the frequency of the signal is within frequency range f₈ (step 776). If the signal does have a frequency within frequency range f₈, filar 1 600a is terminated in a short circuit to ground (step 780) and the signal is provided to filar 1 600a (step 772).

Accordingly, by controlling the feed providing the radar frequency signal from the radar transceiver 312 to the filars 600 of the antenna 112, and by controlling the position of the switches 624, the provided signal may be efficiently transmitted by the antenna 112. Furthermore, it can be appreciated that eight different center frequencies can efficiently be transmitted and received by this embodiment of an antenna 112 in accordance with the present invention.

In general, the anticipated operating conditions of the antenna 112 determines the number of filars and whether switches are provided to selectively ground the filars. For instance, in certain soils, such as bentonite clay, an adequate bandwidth can be obtained using four filars without switches to selectively ground the filars. In sandy soils, it may be necessary to provide four filars with switches to selectively ground the filars in order to achieve the desired bandwidth.

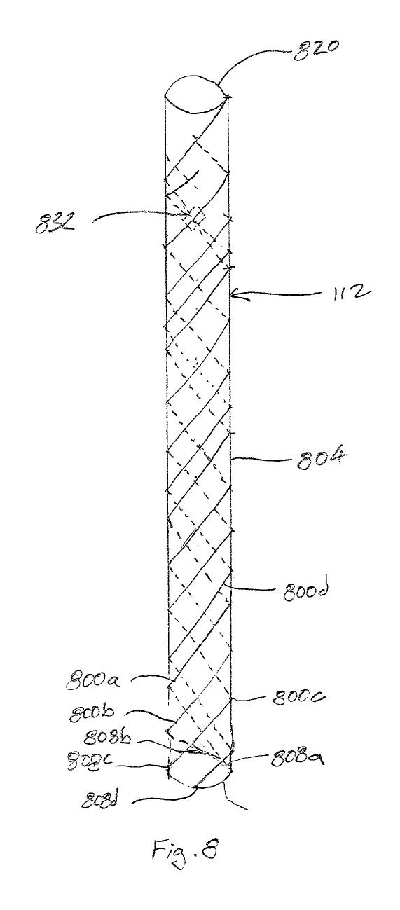

With reference now to FIG. 8, yet another embodiment of an antenna 112 in accordance with the present invention is illustrated. The antenna 112 depicted in FIG. 8 includes four filars 800a, 800b, 800c and 800d. Each of the filars 800a-d has a feed end 808a, 808b, 808c and 808d aligned with a first end 812 of the support member 804. In addition, the longest of the filars 800a extends along substantially the entire length of the support member 804, from the first end 812 to the second end 820. However, each of the other filars 800a-c extends a shorter distance along the support member 804. This is because each of the filars 800a-d is a different length, and because each of the filars 800a-d completes about four revolutions about the support member 804. Each of the filars 800a-d is a different length so that each is capable of efficient operation at a different operating frequency or range of frequencies. By choosing appropriate filar 800a-d lengths, the antenna 112 can provide efficient operation over a broad bandwidth ratio.

It will be appreciated that the antenna 112 illustrated in FIG. 8 includes a feed to selectively interconnect the filars 800 to the radar transceiver 312. As can also be appreciated, the feed (not shown) for the antenna 112 illustrated in FIG. 8 would include a four position switch at the distribution point so that the filars 800a-d can be selectively used in connection with those frequencies that each can most efficiently transmit and receive.

The embodiment of the antenna 112 illustrated in FIG. 8 can be seen to have a crossover 832 between filars 800a and 800d. The crossover 832 is the result of the particular geometry of the antenna 112 illustrated in FIG. 8. At the point of intersection (i.e. at the crossover 832) measures are taken to reduce or eliminate any alteration to the electrical characteristics of the filars 800a and 800d that would otherwise be caused by their intersecting.

The antenna 112 illustrated in FIG. 8 may be particularly advantageous for use in lower loss soils (i.e. soils having a lower dielectric constant). For example, when used in connection with mineral exploration, the relatively long filars 800 and the larger number of revolutions may be preferable to embodiments having shorter filars making fewer revolutions about the support member 804. In accordance with one embodiment, the longest filar 800a is about 72″ long. The support member 804 is about 60″ long and has a diameter of about 2⅜″.

Although the examples given above have been in terms of helical antennas having filars that complete about ¾ of a revolution or about four revolutions along the length of the supporting structure, other configurations of helical antennas may be used. For example, the filars may each complete from about ¼ revolution to about five revolutions. In addition, although as many as four separately excited filars of different lengths are shown in the figures, additional separately excitable filars may be used to increase the bandwidth ratio. For example, an antenna in accordance with the present example may be provided with eight separately excitable filars. Alternatively, an antenna in accordance with an embodiment of the present invention may be provided with a single helical filar. Additionally, the support member can be formed from a number of components. For example, the support member may include an inner metallic cylinder for interfacing with the drill string covered by a dielectric material for carrying the filars, the feed, and any other associated electronics.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A multi-element helical antenna, comprising:
a support member having a cylindrical outer surface; and
a plurality of filars wound about said dielectric support member, wherein each of said filars completes at least a partial revolution along a length of said support member, and wherein each of said filars has a different length.

2. The antenna of claim 1, wherein each of said plurality of filars has a length corresponding to a different operating frequency, and wherein each of said plurality of filars is adapted to operate at a different range of frequencies.

3. The antenna of claim 1, further comprising a feed, wherein said plurality of filars are interconnected to said feed at a first end.

4. The antenna of claim 1, further comprising a plurality of feeds, wherein each of said plurality of filars are interconnected to a corresponding feed at a first end.

5. The antenna of claim 1, wherein said plurality of filars are terminated in an open circuit at a second end.

6. The antenna of claim 1, wherein said plurality of filars are terminated in a short circuit to ground at a second end.

7. The antenna of claim 1, further comprising at least a first switch, wherein in a first condition at least a first of said plurality of filars is terminated at a second end in an open circuit and in a second condition said at least a first of said plurality of filars is terminated at said second end in a short circuit to ground by operation of said switch.

8. The antenna of claim 7, wherein in said first condition said at least a first of said plurality of filars is operable over a first range of frequencies, and wherein in said second condition said at least a first of said plurality of filars is operable over a second range of frequencies.

9. The antenna of claim 1, further comprising a plurality of switches, wherein a one of said plurality of switches is interconnected to each of said plurality of filars, and wherein each of said plurality of switches is operable to selectively terminate a corresponding one of said plurality of filars in at least one of an open circuit and a short circuit.

10. The antenna of claim 5, wherein a length of a first of said plurality of filars is equal to an odd multiple of a distance equal to ¼ of an operating wavelength of said first of said plurality of filars.

11. The antenna of claim 6, wherein a length of a first of said plurality of filars is equal to a multiple of a distance equal to ½ of an operating wavelength of said first of said plurality of filars.

12. The antenna of claim 1, wherein said support member is formed from a dielectric material.

13. The antenna of claim 1, wherein a diameter of said support member is about 0.1 times a wavelength of an operating frequency of a first of said plurality of filars.

14. The antenna of claim 1, wherein each of said filars completes less than 2 revolutions along a length of said support member.

15. The antenna of claim 1, wherein each of said filars completes from about ¼ to about 1 revolution along a length of said support member.

16. The antenna of claim 1, wherein said antenna has a range of operating frequencies from about 25 MHZ to about 400 MHZ.

17. The antenna of claim 1, wherein said support member is mounted concentrically about a drill string.

18. The antenna of claim 1, wherein said filars are supported by said cylindrical outer surface of said support member.

19. The antenna of claim 1, wherein each of said filars completes the same at least a partial revolution along a length of said support member.

20. A method for providing an antenna resonant at a predetermined range of frequencies, comprising:
providing a plurality of single filar antenna elements, wherein each of said antenna elements is a different length;
arranging said antenna elements in at least a partial spiral about a cylindrical support member;
exciting a first of said single filar antenna elements at a first frequency; and
exciting a second of said single filar antenna elements at a second frequency.

21. The method of claim 20, further comprising exciting a third of said single filar antenna elements at a third frequency.

22. The method of claim 21, further comprising exciting an nth of said single filar antenna elements at an nth frequency.

23. The method of claim 20, further comprising switching a first of said filars from a first mode of operation in which said first filar is terminated in an open circuit to a second mode of operation in which said first filar is terminated in a short circuit to ground.

24. The method of claim 23, further comprising exciting said first filar at a third frequency when said first filar is switched to said second mode of operation.

25. The method of claim 20, wherein said at least a partial spiral is less than two complete revolutions.

26. The method of claim 20, wherein said at least a partial spiral is from about ¼ to about 1 revolution.

27. The method of claim 20, wherein said antenna elements have a length equal to an odd multiple of a distance equal to about ¼ of an operating wavelength.

28. The method of claim 20, wherein a radiation pattern of said antenna is concentrated along an axis of said antenna.

29. The method of claim 20, wherein said first and said second frequencies have good penetration characteristics through earth.

30. The method of claim 20, further comprising mounting said antenna on a drill string, wherein said antenna is used in connection with detecting underground obstacles in a direction of travel of a horizontal directional drill.

31. The method of claim 30, further comprising providing a drilling slurry about an exterior of said antenna.

32. The method of claim 18, further comprising exciting said first of said single filar antenna elements at a third frequency.

33. A multi-element helical antenna, comprising:
a drill;
a base unit;
a drill string interconnecting said drill and said base unit;
a cylindrical support member mounted concentrically about a portion of said drill string;
at least a first helical antenna element mounted to said cylindrical support member, wherein said at least a first helical antenna element has a first length and completes at least a partial revolution along its length; and
a feed, wherein said at least a first helical antenna element is supplied with a signal having at least a first frequency.

34. The antenna of claim 33, further comprising at least a second helical antenna element, wherein said at least a second helical antenna element has a second length, different from said first length, and wherein said feed supplies a signal having at least a second frequency to said at least a second helical antenna element.

35. The antenna of claim 34, wherein said first length is equal to an odd multiple of a distance equal to ¼ a wavelength of said signal having said at least a first frequency, and wherein said second length is equal to an odd multiple of a distance equal to ¼ a wavelength of said signal having said at least a second frequency.

36. The antenna of claim 33, further comprising a first switch, for selectively terminating said at least a first helical antenna element in an open circuit when said switch is in a first position and ground when said switch is in a second position.

37. The antenna of claim 36, wherein said at least a first frequency has a wavelength that is about equal to an odd multiple of ½ said first length when said switch is in said second position.

38. The antenna of claim 34, further comprising a crossover at a point of intersection between said first and second helical antenna elements, wherein said first and second helical antenna elements are prevented from being in electrical contact with one another.
